(19) United States
(12) Patent Application Publication
(10) Pub. No.: US 2013/0101407 A1
(43) Pub. Date: Apr. 25, 2013

(54) PELTON TURBINE HAVING A WATER DRAIN SYSTEM

(71) Applicants: Reiner Mack, Dettingen (DE); Wolfgang Rohne, Heidenheim (DE)

(72) Inventors: Reiner Mack, Dettingen (DE); Wolfgang Rohne, Heidenheim (DE)

(21) Appl. No.: 13/261,533

(22) PCT Filed: Apr. 21, 2011
(86) PCT No.: PCT/EP2011/002067

§ 371 Date: Dec. 4, 2012

(30) Foreign Application Priority Data
Jun. 21, 2010 (DE) 102010024475.9

(51) Int. Cl. F03B 7/00

(52) U.S. Cl. CPC F03B 7/00
USPC 415/202

(57) ABSTRACT

The invention relates to a Pelton turbine
comprising a blade wheel which carries a number of Pelton buckets on its circumference;
comprising two or more nozzle bodies for applying a water jet to the Pelton buckets;
a guide wall which is annular in relation to the rotational axis and is provided for discharging spray water is disposed on each side of the blade wheel and radially outside of the Pelton buckets;
the guide wall comprises openings for accommodating one respective nozzle body;
each nozzle body extends with its orifice at least up to the inner radius of the guide wall.

This application claims priority from PCT Application No. PCT/EP2011/002067 filed Apr. 21, 2011 which claims priority from German Application No. DE 10 2010 024 475.9 filed on Jun. 21, 2010, which applications are incorporated herein by reference.

### TECHNICAL FIELD

The invention relates to a Pelton turbine, comprising a blade wheel with a plurality of buckets, two or more nozzles for directing a water jet onto the buckets, and one respective annular guide wall on either side of the blade wheel for discharging spray water, which guide walls are coaxial to the blade wheel. Reference is hereby made to WO 2006/066691 A1.

### BACKGROUND OF THE INVENTION

The effective head in the nozzles is converted into kinetic energy in a Pelton turbine. The buckets are generally double buckets, the two bowls of which are separated from one another by a blade. The water jet is deflected in the bucket by virtually 180°. As a result, nearly the entire kinetic energy of the water jet will be converted into mechanical energy on the circumference of the blade wheel. The remaining residual energy in the deflected jet is still only approximately 2 to 4%. The deflected water jet travels as spray water substantially in the axial direction away from the plane of the blade wheel and impinges on a turbine housing or the free surface of the tail race.

The spray water is discharged by the aforementioned guide walls. This allows reducing the so-called free suspension in Pelton turbines with a horizontal shaft, i.e. the distance between the blade wheel shaft and the tail water level. Height of fall can be gained thereby. A larger number of nozzles can be provided as a result of the improved discharge of spring water. Energy density is increased thereby.

In the known embodiment according to the mentioned specification, the nozzle bodies for applying the water jets are arranged radially outside of the spray-water-discharging guide walls. The guide walls are therefore provided with boreholes through which the water jet will pass. As is known, the water jet will have a differently large diameter depending on the amount of water. The boreholes are provided with a clear width in order to receive the water jet with the largest possible diameter. It is thereby prevented that the water jet will touch the intrados of the borehole because frictional energy will occur thereby which will reduce the efficiency of the turbine.

### SUMMARY OF THE INVENTION

The invention is based on the object of providing a Pelton turbine in such a way that efficiency will be improved even further, especially by measures in the region of the nozzles and the guide walls.

The inventors have recognized that even a borehole diameter in the guide wall which is too large and in which an air-filled annular space remains between the water jet and the intrados of the borehole is unfavorable.

Accordingly, the guide walls are provided with openings which are not only able to accommodate the water jet but also the nozzle head which is substantially larger in its diameter. Furthermore, the nozzle is guided through the respective guide wall, so that its orifice is disposed on the radially inner surface of the guide wall which is contacted by the spray water. The orifice could also protrude radially inwardly beyond the spray-water-contacted surface of the guide wall. In the case of such a configuration, the water jet will therefore not pass directly through the borehole in the guide wall, but will exit as an entirely unguided free jet from the orifice of the nozzle and will reach the buckets directly.

The inventors have further recognized that in the state of the art spray water will spray back into the borehole after the impinging of the water jet on the Pelton bucket and will disturb the jet. Such a disturbance is prevented in the embodiment in accordance with the invention.

It has been noticed that efficiency is improved over known embodiments. Contact between water jet and the intrados of a borehole is prevented.

### BRIEF DESCRIPTION OF THE DRAWINGS

The state of the art and the invention are explained in closer detail by reference to the drawings which show the following in detail:

FIG. 1 illustrates an embodiment according to the state of the art, namely according to the aforementioned specification WO 2006/066691 A1;

FIG. 2 shows the Pelton turbine according to FIG. 1 in an axially perpendicular sectional view;

FIG. 3 shows the turbine according to the invention in an axial sectional view;

FIG. 4 shows the turbine according to FIG. 3 in an axial perpendicular view.

### DETAILED DESCRIPTION OF THE PREFERRED EMBODIMENTS

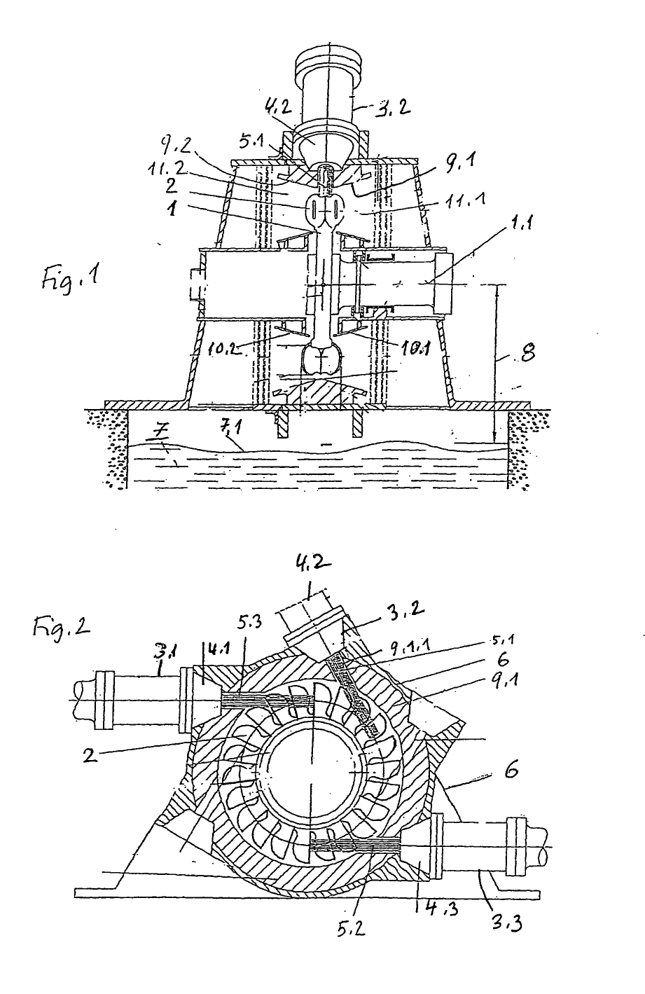

The Pelton turbine shown in FIGS. 1 and 2 comprises a blade wheel 1 with a horizontal rotational axis 1.1. A plurality of Pelton buckets 2 is fastened to the circumference of the blade wheel 1.

The illustration shows three nozzles. They respectively comprise one nozzle body 3.1, 3.2, 3.3. Every nozzle body carries one respective nozzle head at its free end, namely 4.1, 4.2, 4.3.

A water jet 5.1, 5.2 and 5.3 exits from the nozzles, which water jet is directed against the Pelton buckets 2. As is shown in FIG. 2, two further receiving openings are provided for accommodating one respective further nozzle head.

The Pelton turbine comprises a housing 6. The spray water which is deflected in the buckets is ejected against the inside walls of the housing 6 and reaches the tail race 7 with a level 7.1. The so-called free suspension 8 is the distance between the rotational axis 1.1 of the blade wheel 1 and the tail race level 7.1.

The illustration of FIG. 1 shows that two annular guide walls 9.1, 9.2 are provided on either side of the blade wheel 1 and radially outside of the Pelton buckets 2. Furthermore, two respective guide walls 10.1, 10.2 are provided, which are again disposed on either side of the blade wheel 1 or radially within the Pelton buckets 2.

This guide wall pairing represents a spray water discharge channel 11.1, 11.2, respectively on one side of the blade wheel 1, by means of which the spray water from the Pelton buckets 2 is guided away.

The arrangement of the nozzle heads 4.1, 4.2, 4.3 is of special interest. They are disposed substantially radially outside of the guide walls 9.1, 9.2. The guide walls comprise boreholes, of which only one borehole 9.1.1 can be seen. The water jet exiting from the respective nozzle body passes through the said borehole and therefore reaches the Pelton bucket 2. The clear width of the borehole is sufficiently large to also permit the passage of a water jet of a large diameter.

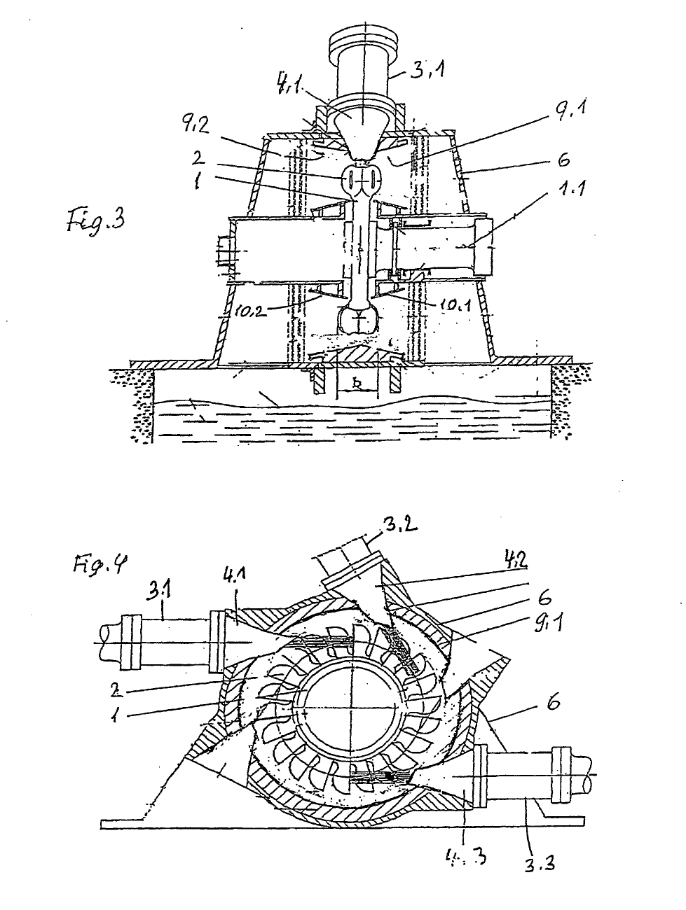

The turbine in accordance with the invention is different (see FIGS. 3 and 4). In this case, a sufficiently large opening is provided in the radially outer guide walls 9.1, 9.2, through which the respective nozzle head 4.1, 4.2, 4.3 is guided, which occurs radially to the inside to such an extent that its orifice is disposed at the radially inner end of the guide walls 9.1, 9.2. The respective water jet now exits as a completely free jet from the orifice of the respective nozzle head 4.1, 4.2, 4.3 without having to pass through a borehole such as the borehole 9.1.1. This leads to a considerable increase in the efficiency of the entire Pelton turbine in accordance with a turbine according to the state of the art.

Although the water-guiding surfaces of the guide walls 9.1, 9.2 and 10.1, 10.2 are provided with an inclination against the rotational axis 1.1 of the blade wheel 1, they could also be provided with a different angle against the rotational axis, e.g. they could extend in parallel with respect to said axis.

It is also possible to omit the inner guide walls 10.2.

In accordance with a further idea of the invention, the guide walls 9.1, 9.2 and/or 10.1, 10.2 are not arranged as continuous rings, but as ring segments which jointly form a ring.

The segments can be arc-shaped. They can also be arranged in a straight line.

If the guide walls are segmented in this manner, the two ends of two mutually adjacent segments can have a distance from one another in which there is enough space for a nozzle body 3.1, 3.2, 3.3.

The nozzle bodies can be fixedly connected with the guide walls. They can also be mounted freely from said walls and be fixedly connected with the housing 6.

The aforementioned configuration in segments offers the advantage of simple and easy mounting in the case of retrofitting a conventional turbine.

The external and/or internal guide walls can be unified from a constructional point of view, or they can consist of one integral component. This applies to the embodiment with continuous rings or also to the segmented embodiment.

The turbine can be provided with a vertical or a horizontal rotational axis. The rotational axis can also be inclined to the horizontal.

If a turbine is concerned with horizontal rotational axis or one that is inclined to the horizontal, a guide wall can be used which only consists of one arc segment which encloses the upper or one upper region of the blade wheel.

### LIST OF REFERENCE NUMERALS

1 Blade wheel
1.1 Rotational axis of the blade wheel
2 Pelton bucket
3.1 Nozzle body
3.2 Nozzle body
3.3 Nozzle body
4.1 Nozzle head
4.2 Nozzle head
4.3 Nozzle head
5.1 Water jet
5.2 Water jet
5.3 Water jet
6 Housing
7 Tail race
7.1 Tail race level
8 Free suspension
9.1 Guide wall
9.1.1 Borehole
9.2 Guide wall
10.1 Guide wall
10.2 Guide wall

1. A Pelton turbine,
comprising a blade wheel which carries a number of Pelton buckets on its circumference;
two or more nozzle bodies for applying a water jet to the Pelton buckets;
a guide wall which is annular in relation to the rotational axis is provided for discharging spray water and is disposed on both sides of the blade wheel and radially outside of the Pelton buckets;
the guide wall comprises openings for accommodating one respective nozzle body;
each nozzle body extends with its orifice at least up to the inner radius of the guide wall;
a further annular guide wall for discharging spray water is provided radially within the Pelton buckets;
characterized by the following features:
the individual guide wall and/or is composed of segments which extend in the circumferential direction; and,
an opening leading through a nozzle body is provided between the mutually facing ends of two mutually adjacent segments.

2. A Pelton turbine according to claim 1, characterized in that the guide wall is arranged coaxially to the rotational axis of the blade wheel (1).

3. A Pelton turbine according to claim 1, characterized in that the guide wall is conical or cylindrical, or it expands in the manner of a trumpet with increasing distance from the blade wheel.

4. A Pelton turbine according to claim 1, characterized in that the distance between the radially outer end of the Pelton buckets and the radially inner end of the guide wall is at least equal to the radial extension of each Pelton bucket.

5. A Pelton turbine according to claim 1, characterized in that
the nozzle bodies are free from any mechanical connection with the guide walls.

6. A Pelton turbine according to claim 1, characterized by the following features:
the rotational axis of the blade wheel extends horizontally or vertically or is inclined to the horizontal; and,
at least one of the guide walls is only a ring segment which leaves open at least a substantial part of the bottom circumference of the blade wheel.

7. A Pelton turbine according to claim 2, characterized in that the guide wall is conical or cylindrical, or it expands in the manner of a trumpet with increasing distance from the blade wheel.

8. A Pelton turbine according to claim 2, characterized in that the distance between the radially outer end of the Pelton buckets and the radially inner end of the guide wall is at least equal to the radial extension of each Pelton bucket.

9. A Pelton turbine according to claim 3, characterized in that the distance between the radially outer end of the Pelton buckets and the radially inner end of the guide wall is at least equal to the radial extension of each Pelton bucket.

10. A Pelton turbine according to claim 2, characterized in that the nozzle bodies are free from any mechanical connection with the guide walls.

11. A Pelton turbine according to claim 3, characterized in that the nozzle bodies are free from any mechanical connection with the guide walls.

12. A Pelton turbine according to claim 4, characterized in that the nozzle bodies are free from any mechanical connection with the guide walls.

13. A Pelton turbine according to claim 2, characterized by the following features:
the rotational axis of the blade wheel extends horizontally or vertically or is inclined to the horizontal; and,
at least one of the guide walls is only a ring segment which leaves open at least a substantial part of the bottom circumference of the blade wheel.

14. A Pelton turbine according to claim 3, characterized by the following features:
the rotational axis of the blade wheel extends horizontally or vertically or is inclined to the horizontal; and,
at least one of the guide walls is only a ring segment which leaves open at least a substantial part of the bottom circumference of the blade wheel.

15. A Pelton turbine according to claim 4, characterized by the following features:
the rotational axis of the blade wheel extends horizontally or vertically or is inclined to the horizontal; and,
at least one of the guide walls is only a ring segment which leaves open at least a substantial part of the bottom circumference of the blade wheel.

16. A Pelton turbine according to claim 5, characterized by the following features:
the rotational axis of the blade wheel extends horizontally or vertically or is inclined to the horizontal; and,
at least one of the guide walls is only a ring segment which leaves open at least a substantial part of the bottom circumference of the blade wheel.
